(19) United States
(12) Patent Application Publication
(10) Pub. No.: US 2006/0208397 A1
(43) Pub. Date: Sep. 21, 2006

(54) Method for manufacturing formed honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK Insulators, Ltd., Nagoya-city (JP)

(21) Appl. No.: 11/373,912

(22) Filed: Mar. 14, 2006

(30) Foreign Application Priority Data
Mar. 17, 2005 (JP) 2005-077535
Jan. 19, 2006 (JP) 2006-011363

(51) Int. Cl. C04B 35/64

(52) U.S. Cl. 264/631; 264/169

(57) ABSTRACT

A method for manufacturing a formed honeycomb structure in an efficient manner which comprises the steps of: charging a material for forming a honeycomb structure 5 into a passage 22 for preform material for a honeycomb structure whose one end portion is provided with die 3 for forming a formed honeycomb structure; and extruding the charged preform material for a honeycomb structure 5 from the die 3 to form a formed honeycomb structure 10 while passing it through the passage, wherein a screen 4 for filtering foreign matters included in the preform material for a honeycomb structure 5 is disposed in the vicinity of the die 3, and wherein an operation for reduction of frictional resistances between an inner face of the passage 22 for preform material for a honeycomb structure and the preform material for a honeycomb structure 5 which passes the passage is employed.

### BACKGROUND OF THE INVENTION

1. Field of the Invention

The present invention relates to a method for manufacturing a formed honeycomb structure, more particularly to a method for manufacturing a formed honeycomb structure, said method being capable of reducing an influence on extrusion forming due to the formation a boundary portion between a previously charged material for forming a honeycomb structure and a subsequently charged material for forming a honeycomb structure in a case where the extrusion forming is performed by adding a new material for forming a honeycomb structure at a time when the material for forming a honeycomb structure charged in a forming machine decreases, so that the material for forming a honeycomb structure charged in the forming machine is effectively usable.

2. Description of the Related Art

There is broadly used a honeycomb structure provided with partition walls which defines composite cells comprising a plurality of cells adjacent to one another as a filter for capturing and removing particulate substances included in a dust containing fluid such as a diesel engine exhaust gas (diesel particulate filter (DPF)), or as a catalyst carrier for purifying the exhaust gas which carries catalyst components for purifying toxic substances in the exhaust gas.

Such honeycomb structure is manufactured by forming the material for forming a honeycomb structure including a ceramic and the like into a honeycomb shape to obtain a formed honeycomb structure, and firing this formed honeycomb structure,

There is used a method of charging a passage for preform material for a honeycomb structure of a forming machine with, for example, a material for forming a honeycomb structure including the ceramic and the like, and extruding the material for forming a honeycomb structure from a die for forming the formed honeycomb structure, the die being disposed in one end portion of the passage for material for forming a honeycomb structure, in a case where the material for forming a honeycomb structure is extruded to obtain the formed honeycomb structure (e.g., JP-A-53-21209).

Examples of the method for extruding a material for forming a honeycomb structure to form the formed honeycomb structure include a ram or plunger type extrusion forming method, and combining or continuous extrusion forming method.

In the ram or plunger type extrusion forming, as shown in FIG. 7, a predetermined material powder is mixed with water by a mixer 35, the resultant mixture is then kneaded with a clay kneader 33, and further the resultant clay is kneaded under vacuum to thereby prepare a material for forming a honeycomb structure 25. As shown in FIGS. 8(a) and 8(b), a predetermined amount of the resultant material 25 for forming a honeycomb structure is shaped into, as a shaped material for forming a honeycomb structure by extrusion (hereinafter usually referred to as a preform material for a honeycomb structure), a cylindrical cluster of clay having a predetermined length. Usually, the size of the cylindrical cluster is chosen in accordance with the size of the passage 22 (the inner diameter of the passage 22) which is used for passing the perform material for a honeycomb structure there through under pressure until the extrusion of the preform material for a honeycomb structure from the die. The passage 22 is usually referred to as a passage 22 for a preform material for a honeycomb structure. The passage 22 constituting a part of a forming machine 21 is charged with thus formed preform material for a honeycomb structure, for example, a formed cylindrically shaped material for a honeycomb structure 25a, and the charged material is extruded from the die 23 for forming the extruded formed honeycomb structure by use of a plunger 31 for pressing the charged preform material for a honeycomb structure 25a for forming a honeycomb structure 25.

However, note that the shaped material to be charged into the passage, that is, the preform material for a honeycomb structure may take any form selected from the group consisting of the columnar like shape including the cylindrical form, polygonal shape such as heptagonal, hexagonal, octagonal, a race-truck like shape, elliptical shape, or the like as far as such a shape is adoptable as a filter, or DPF or the like.

In such conventional method for manufacturing a formed honeycomb structure, to efficiently manufacture a formed honeycomb structure 30 from one batch of charged material for forming a honeycomb structure 25, firstly a preform material for a honeycomb structure, such as, for example, a cylindrically shaped material 25a having a volume of sufficiently larger than that of the formed honeycomb structure 30 to be manufactured is prepared, and then the cylindrically shaped material 25a is charged into the passage 22.

For this purpose, the passage 22 for a preform material for a honeycomb structure is constituted of: a cylinder 26 whose inner diameter is larger than an outer diameter of the formed honeycomb structure 30 to be manufactured; and a drum 27 (e.g., reduction drum) for reducing a size of the material for forming a honeycomb structure 25 down to a size of the formed honeycomb structure 30 during the pressing of the material. The preform material for a honeycomb structure 25a has a size of larger than the outer diameter of the formed honeycomb structure 30 and longer in an extruding direction.

Between the cylinder 26 and the drum 27, there is disposed a screen 24 for removing coarse foreign matters unavoidably included in the material for forming a honeycomb structure 25. This screen 24 is held by a holding portion 36 so as to stand a pressure during the pressing of the material for forming a honeycomb structure 25, and the screen has a structure which is comparatively thick in the extruding direction of the preform material for a honeycomb structure.

A thin sheet-shaped metal mesh is used in the screen 24, and a disc-shaped metal-made porous plate having a large number of through holes is used for the holding portion 36 of the screen.

Moreover, in recent years, to satisfy needs for a heavy duty diesel truck, a formed honeycomb structure having a large sectional area needs to be formed, the drum 27 is enlarged toward the die 23 for forming the formed honeycomb structure, and the larger formed honeycomb structure 30 is manufactured.

Furthermore, in the conventional method for manufacturing a formed honeycomb structure wherein the combining forming method has been utilized, although not shown, a process including mixing, kneading, clay kneading, and extrusion is combined and performed in one production system.

The cylinder for use in the conventional method for manufacturing a formed honeycomb structure has a construction which is comparatively long in the extruding direction. Even when the size of the formed honeycomb structure to be manufactured changes, the fixed cylinder has been used without being changed. Therefore, the size of the material for forming a honeycomb structure to be charged has been also fixed.

For example, in a case where the outer diameter of the formed honeycomb structure to be formed is changed, when the outer diameter should have been set to be smaller than the inner diameter of the cylinder, the cylinder is connected to the die for forming the formed honeycomb structure by the reduction drum. For example, in a case where the outer diameter of the formed honeycomb structure should have been set to be larger than the inner diameter of the cylinder, the cylinder is connected to the die for forming the formed honeycomb structure by an enlargement drum.

An angle formed by the inner face of the drum and the extrusion direction is determined by a relation between the outer diameter of the preform material for a honeycomb structure and that of the resultant formed honeycomb structure so that a length of the drum having a function of such reduction or enlargement path in the extruding direction has a gradient as moderate as possible without being rapidly reduced or enlarged. Usually, the length of the drum in the extruding direction is sufficiently large, and the length is set to be approximately twice or more the outer diameter (in some instances the inner diameter of the cylinder) of the preform material for a honeycomb structure to be charged.

Therefore, in the conventional method for manufacturing formed honeycomb structure, the plunger for pressing the preform material for a honeycomb structure can be pressed only before it reaches the drum, and some of the preform material for a honeycomb structure therefore naturally remains in the drum.

In case of the conventional method for manufacturing formed honeycomb structure illustrated in FIGS. 8(a) and 8(b), the screen 24 is held by the holding portion 36 between the cylinder 26 and the drum 27, but a flow of the preform material for a honeycomb structure 25 is reduced in this holding portion 36, and a pressure fluctuation is generated.

Moreover, to secure a structural strength of the holding portion 36, the structure is thick in the extruding direction. Therefore, when the preform material for a honeycomb structure 25 passes through the screen 24, the preform material for a honeycomb structure 25 undergoes the pressure fluctuation over the thickness of the holding portion 36.

Especially in a case where the forming step happens to delay, a fluctuation is generated in the characteristics of the preform material for a honeycomb structure 25 in a portion where the flow of the preform material for a honeycomb structure 25 is reduced.

In a case where the forming is restarted, and the portion of the preform material for a honeycomb structure 25 having the reduced flow is extruded to form the formed honeycomb structure, the resultant formed honeycomb structure 30 is sometimes bent. A forming defect is generated in some case. Therefore, the extruded formed honeycomb structure 30 including this portion cannot be used as a product in some case.

Such phenomenon is generated in either of the ram type (plunger type) extrusion forming and the combining (continuous) extrusion forming.

For example, at the time when a new charge of 25 becomes necessary due to the decrease of the preform material for a honeycomb structure 25 previously charged, the extrusion step should be stopped to charge the new batch of the preform material for a honeycomb structure 25. The extrusion step is once stopped in a state in which the flow of the preform material for a honeycomb structure 25 is reduced in the passage 22 of the die, and the characteristics of the preform material for a honeycomb structure 25 are apt to fluctuate.

Moreover, in a case where the new batch of the preform material for a honeycomb structure 25 for is charged to restart the extrusion step, the previous preform material for a honeycomb structure 25b remains in the screen 24, the drum 27, and the die 23 for forming the formed honeycomb structure. Therefore, a boundary portion 28 is formed between the remained preform material for a honeycomb structure 25b and the newly charged preform material for a honeycomb structure 25a, and thus formed boundary portion 28 remains in the extruded formed honeycomb structure 30.

Such boundary portion 28 is not continuous with relation to the preform material for a honeycomb structure 25, and a defect such as a void is easily formed in the formed structure.

The contraction of the preform material for a honeycomb structure 25 in the drum 27 causes the fluctuation in the characteristics of the preform material for a honeycomb structure or in the speed distribution of the preform material for a honeycomb structure 25 in a section perpendicular to the extruding direction, and the distribution in the speeds for extrusion of the preform material for a honeycomb structure 25 gives a parabolic curve.

The boundary portion 28 between the preform material for a honeycomb structure 25b remaining in the passage 22 of the die or the like and the newly charged preform material for a honeycomb structure 25a gradually forms a parabolic shape in the drum 27 as the preform material for a honeycomb structure 25 flows. The portion is distributed long in the extruding direction, and such portion often is included in a plurality of extruded formed honeycomb structures 30.

As described above, in the conventional method for manufacturing formed honeycomb structure, in a case where the preform material for a honeycomb structure 25a is added later to form the honeycomb structure with the decrease of the preform material for a honeycomb structure 25 charged in the forming machine 21, the formed honeycomb structure including the boundary portion 28 between the previously charged preform material for a honeycomb structure 25b and the newly charged preform material for a honeycomb structure 25a cannot be used as a plurality of products. Therefore, there is a problem that some part of the preform material for a honeycomb structure 25 becomes waste until all of the preform material for a honeycomb structure 25 including the boundary portion 28 is extruded out completely.

On the other hand, in case of the continuous extrusion process, the boundary portion in the preform material for a honeycomb structure is not formed since there is no necessity of charging preform material for a honeycomb structure later, but a kneading step is performed by an in-line screw. Therefore, the material for forming a honeycomb structure is kneaded insufficiently, and viscosity is not easily imparted to the material for forming a honeycomb structure. Therefore, to improve the viscosity and secure formability, the improvement in the production facility is required for a purpose of reinforcing a kneading function, such an operation that a binder should be added in excess to the material for forming a honeycomb structure or the like. There is a problem that manufacturing costs increase.

Furthermore, there is a problem that facilities for securing an extruding pressure become huge with the increase of the outer diameter of the formed honeycomb structure.

### SUMMARY OF THE INVENTION

The present invention has been developed in view of such conventional situations, and an object is to provide a method for manufacturing a formed honeycomb structure; said method being capable of reducing an influence on the extrusion forming step due to the formation of a boundary portion between a previously charged preform material for a honeycomb structure and a subsequently charged preform material for a honeycomb structure in a case where the extrusion forming step is performed by adding a new preform material for a honeycomb structure at a time when the amount of the preform material for a honeycomb structure charged in a forming machine decreases, so that the preform material for a honeycomb structure charged in the forming machine is effectively usable.

The present invention provides the following method for manufacturing a formed honeycomb structure.

[1] A method for manufacturing a formed honeycomb structure, comprising the steps of: charging, with a preform material for a honeycomb structure, a passage whose one end portion is provided with a die for extruding the formed honeycomb structure; and extruding the charged preform material for a honeycomb structure from the die to form the formed honeycomb structure, wherein a screen for filtering foreign matters included in the preform material for a honeycomb structure is disposed in the vicinity of the die, and wherein an operation for reducing frictional resistances between an inner face of the passage for preform material for a honeycomb structure and the preform material for a honeycomb structure is provided.

[2] The method for manufacturing the formed honeycomb structure according to the above [1], wherein the screen is disposed in a position where a distance from the die for forming the formed honeycomb structure is twice or less an inner diameter of the passage for preform material for a honeycomb structure.

[3] The method for manufacturing the formed honeycomb structure according to the above [1] or [2], wherein the operation for reducing the frictional resistances between the inner face of the passage for preform material for a honeycomb structure and the preform material for a honeycomb structure is to dispose a lubricating oil or a lubricating material between the inner face of the passage for preform material for a honeycomb structure and the preform material for a honeycomb structure and/or to modify a surface property of the inner face of the passage for preform material for a honeycomb structure.

[4] The method for manufacturing the formed honeycomb structure according to any one of the above [1] to [3], wherein the extrusion of a preform material for a honeycomb structure to form the formed honeycomb structure is carried out by use of the passage for preform material for a honeycomb structure whose inner diameter is enlarged from the position provided with the screen toward the one end portion provided with the die for extruding the formed honeycomb structure.

[5] The method for manufacturing the formed honeycomb structure according to any one of the above [1] to [3], the extrusion of a preform material for a honeycomb structure to form the formed honeycomb structure is carried out by use of the passage for preform material for a honeycomb structure whose inner diameter is reduced toward the one end portion and thereafter enlarged.

[6] The method for manufacturing the formed honeycomb structure according to any one of the above [1] to [3], the extrusion of a preform material for a honeycomb structure to form the formed honeycomb structure is carried out by use of the passage for preform material for a honeycomb structure whose inner diameter is set to be substantially equal to an outer diameter of the formed honeycomb structure to be formed, with employment of a plunger type extrusion forming wherein the preform material for a honeycomb structure is pressed by use of a plunger for pressing the preform material for a honeycomb structure.

[7] The method for manufacturing the formed honeycomb structure according to any one of the above [1] to [6], further comprising the step of: charging the passage for preform material for a honeycomb structure with the preform material for a honeycomb structure of an amount corresponding to that of one formed honeycomb structure to extrude the charged preform material for a honeycomb structure to form a formed honeycomb structure.

According to the method for manufacturing a formed honeycomb structure according to the present invention, one may reduce an influence on the forming due to the formation of a boundary portion between a previously charged preform material for a honeycomb structure and a subsequently charged preform material for a honeycomb structure in a case where the forming is performed by adding newly a preform material for a honeycomb structure at a time when the preform material for a honeycomb structure charged in a forming machine decreases, so that the preform material for a honeycomb structure charged in the forming machine is effectively usable.

Moreover, one may reduce an influence on the formed honeycomb structure even in a case wherein the flow of the preform material for a honeycomb structure is caused to delay; said influence having been derived from the reduction of the flow at the portions where the screen has been disposed in the passage for preform material for a honeycomb structure of the forming machine. When the forming is restarted, it is possible to return to normal forming early.

### BRIEF DESCRIPTION OF THE DRAWINGS

FIG. 1(a) is an explanatory view schematically showing an example of a step of extruding a material for forming a honeycomb structure to form a formed honeycomb structure in an embodiment of a formed honeycomb structure manufacturing method in the present invention;

FIG. 1(b) is an explanatory view schematically showing the example of the step of extruding the material for forming a honeycomb structure to form the formed honeycomb structure in the embodiment of the formed honeycomb structure manufacturing method in the present invention;

FIG. 2(a) is an explanatory view schematically showing another example of a step of extruding a material for forming a honeycomb structure to form a formed honeycomb structure in the embodiment of the formed honeycomb structure manufacturing method in the present invention;

FIG. 2(b) is an explanatory view schematically showing the example of the step of extruding the material for forming a honeycomb structure to form the formed honeycomb structure in the embodiment of the formed honeycomb structure manufacturing method in the present invention;

FIG. 3 is an explanatory view schematically showing a still another example of a step of extruding a material for forming a honeycomb structure to form a formed honeycomb structure in the embodiment of the formed honeycomb structure manufacturing method in the present invention;

FIG. 4 is an explanatory view schematically showing a further example of a step of extruding a material for forming a honeycomb structure to form a formed honeycomb structure in the embodiment of the formed honeycomb structure manufacturing method in the present invention;

FIG. 5(a) is an explanatory view schematically showing a further example of a step of extruding a material for forming a honeycomb structure to form a formed honeycomb structure in another embodiment of the formed honeycomb structure manufacturing method in the present invention;

FIG. 5(b) is an explanatory view schematically showing the example of the step of extruding the material for forming a honeycomb structure to form the formed honeycomb structure in the embodiment of the formed honeycomb structure manufacturing method in the present invention;

FIG. 5(c) is an explanatory view schematically showing the example of the step of extruding the material for forming a honeycomb structure to form the formed honeycomb structure in the embodiment of the formed honeycomb structure manufacturing method in the present invention;

FIG. 6(a) is an explanatory view schematically showing a still further example of a step of extruding a material for forming a honeycomb structure to form a formed honeycomb structure in sill another embodiment of the formed honeycomb structure manufacturing method in the present invention;

FIG. 6(b) is an explanatory view schematically showing the example of the step of extruding the material for forming a honeycomb structure to form the formed honeycomb structure in the embodiment of the formed honeycomb structure manufacturing method in the present invention;

FIG. 7 is an explanatory view schematically showing a step of obtaining a preform material for a honeycomb structure in a conventional formed honeycomb structure;

FIG. 8(a) is an explanatory view schematically showing a step of extruding the material for forming a honeycomb structure to form a formed honeycomb structure in the conventional formed honeycomb structure; and

FIG. 8(b) is an explanatory view schematically showing the step of extruding the material for forming a honeycomb structure to form the formed honeycomb structure in the conventional formed honeycomb structure.

### DESCRIPTION OF THE PREFERRED EMBODIMENT

There will be described hereinafter embodiments of a method for manufacturing a formed honeycomb structure according to the present invention in detail with reference to the drawings, but the present invention is not restrictively interpreted, and various changes, modifications, and improvements can be added based on knowledge of a person skilled in the art without departing from the scope of the present invention.

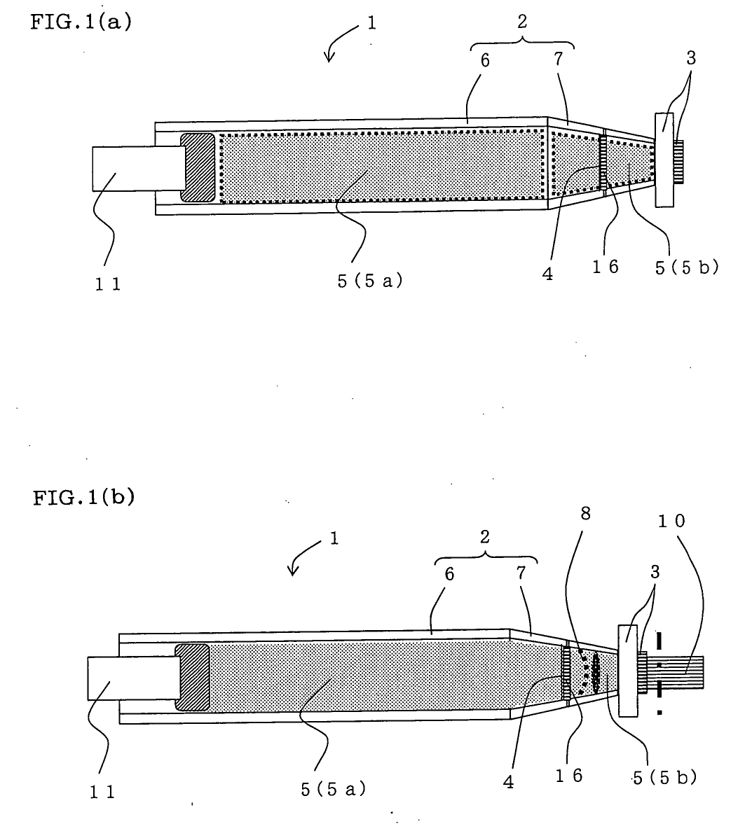

FIGS. 1(a) and 1(b) are explanatory views schematically showing one example of a step of extruding a material for forming a honeycomb structure to form a formed honeycomb structure in one embodiment of the method for manufacturing a formed honeycomb structure according to the present invention. In the present embodiment, the method for manufacturing a formed honeycomb structure may be realized using a forming machine 1 shown in FIGS. 1(a) and 1(b).

This forming machine 1 is a plunger type forming machine including: a cylinder 6 and a drum 7 constituting a passage 22 for preform material for a honeycomb structure; die 3 for extruding a formed honeycomb structure; a screen 4; and a plunger 11 for pressing a material for forming a honeycomb structure.

The method for manufacturing a formed honeycomb structure in the present embodiment is a method for manufacturing formed honeycomb structure which comprises the steps of charging with a preform material for a honeycomb structure 5 the passage 22 for preform material for a honeycomb structure whose one end portion is provided with the die 3 for forming the formed honeycomb structure; and extruding the charged preform material for a honeycomb structure 5 from the die 3 for extruding to form a formed honeycomb structure 10. The screen 4 for filtering foreign matters included in the preform material for a honeycomb structure 5 is disposed in the vicinity of the dies 3 for extruding the formed honeycomb structure in the passage 22 for preform material for a honeycomb structure, and an operation is employed to reduce frictional resistances between an inner face of the passage 22 for preform material for a honeycomb structure and the preform material for a honeycomb structure 5 to obtain the formed honeycomb structure 10.

In the present embodiment, the formed honeycomb structure 10 obtained by the method for manufacturing a formed honeycomb structure is a cylindrical formed structure in which a plurality of through channels are formed being defined by partition walls.

When the resultant formed honeycomb structure 10 is fired, for example, a honeycomb structure can be obtained preferably for use as a filter for capturing dust and treating water or a catalyst carrier for purifying an exhaust gas.

According to the method for manufacturing a formed honeycomb structure in the present embodiment, for example, even in a case where the extrusion forming step is stopped, the preform material for a honeycomb structure 5 which has been stopped in and/or around the screen 4 and caused the fluctuations in characteristics is extruded faster, when the extrusion step is restarted. Therefore, it is possible to remove an influence on the extruded formed honeycomb structure 10 early, and it is possible to return to normal forming earlier.

Moreover, one may reduce an influence on the extrusion forming due to the formation of the boundary portion 8 between a previously charged preform material for a honeycomb structure 5b and a subsequently charged preform material for a honeycomb structure 5a in a case where the preform material for a honeycomb structure 5b charged in the forming machine 1 decreases, and the preform material for a honeycomb structure 5a is added newly to continue the extrusion forming, so that the preform material for a honeycomb structure 5 charged in the forming machine 1 is effectively usable.

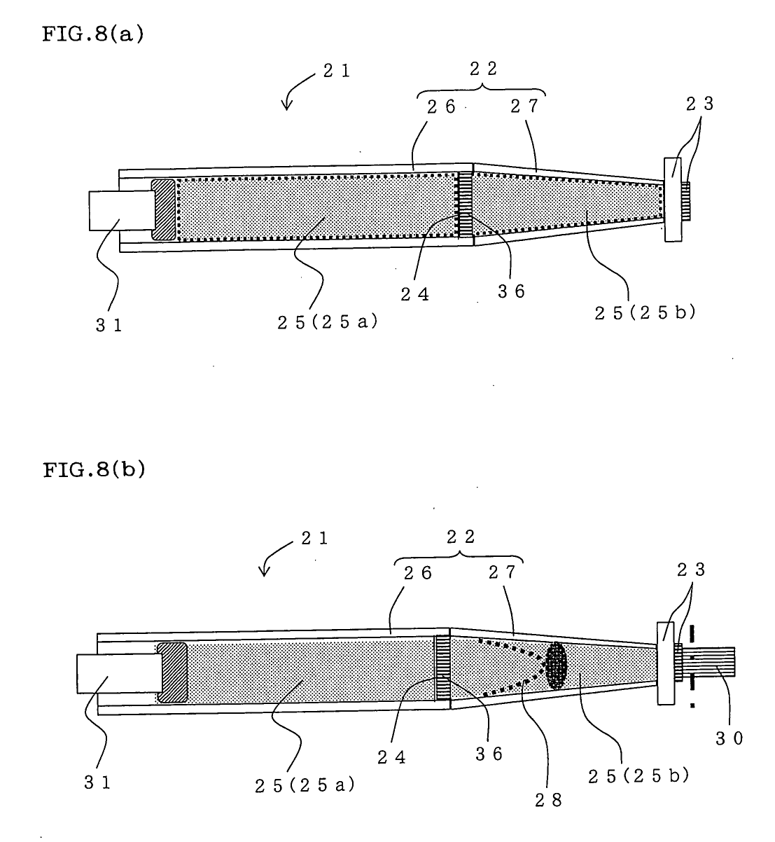

In the conventional method for manufacturing a formed honeycomb structure, as shown in FIGS. 8(a) and 8(b), a passage 22 for preform material for a honeycomb structure 2 is constituted of: a cylinder 26 whose inner diameter is larger than an outer diameter of a formed honeycomb structure 30 to be manufactured; and a drum 27 (e.g., reduction drum) for reducing a size of preform material for a honeycomb structure 25 down to a size of the formed honeycomb structure 30 during the pressing of the material. A screen 24 is held by a holding portion 36 between this cylinder 26 and the drum 27.

The cylinder 26 for use in the conventional manufacturing method has a structure which is comparatively long. Even when the size of the formed honeycomb structure 30 to be manufactured changes, the fixed cylinder 26 should be used without being changed. Therefore, the size of the preform material for a honeycomb structure 25a to be charged is also fixed.

For example, in a case where the outer diameter of the formed honeycomb structure 30 to be formed is changed, for example, the outer diameter should have been set to be smaller than the inner diameter of the cylinder 26, the cylinder 26 should be connected to a die 23 for forming the formed honeycomb structure by the reduction drum 27. For example, in a case where the outer diameter of the formed honeycomb structure is set to be larger than the inner diameter of the cylinder, the cylinder is connected to the die for forming the formed honeycomb structure by an enlargement drum, although not shown.

Therefore, in the case of the conventional method for manufacturing a honeycomb structure, as shown in FIGS. 8(a) and 8(b), the plunger 31 to press the preform material for a honeycomb structure 25 can be pressed the preform material for a honeycomb structure only until before the drum 27, and the preform material for a honeycomb structure 25b therefore remains in the drum 27.

Therefore, in the conventional manufacturing method, an amount of the preform material for a honeycomb structure 25 remained in the passage 22 for preform material for a honeycomb structure is large, an influence on the extrusion forming caused by the formation of the boundary portion 28 between the previously charged preform material for a honeycomb structure 25b and the subsequently charged preform material for a honeycomb structure 25a is large, the boundary portion 28 extends in a plurality of formed honeycomb structures 30, and a large amount of material for forming a honeycomb structure 25 is wasted.

Furthermore, in the conventional method for manufacturing a formed honeycomb structure, frictional resistances between an inner face of the drum 27 and the preform material for a honeycomb structure 25 are large, an extrusion speed of the preform material for a honeycomb structure 25 is high in a central portion of the passage 22 for preform material for a honeycomb structure, this boundary portion 28 spreads in a parabolic shape, and a larger amount of material for forming a honeycomb structure 25 is wasted.

As shown in FIGS. 1(a) and 1(b), in the method for manufacturing a formed honeycomb structure in the present embodiment, the formed honeycomb structure 10 is formed by employing the screen 4 which is disposed in the vicinity of the die 3 for forming the formed honeycomb structure in the passage 22 for preform material for a honeycomb structure, and an operation for the reduction of the frictional resistances between the inner face of the passage 22 for preform material for a honeycomb structure and the preform material for a honeycomb structure 5. As a consequence, the above-described problem of the conventional method is solved, thereby the influence on the extrusion forming step to be caused by the formation of the boundary portion 8 between the previously charged preform material for a honeycomb structure 5b and the subsequently charged preform material for a honeycomb structure 5a can be reduced, and the preform material for a honeycomb structure 5 charged in the forming machine 1 can be effectively used.

In the method for manufacturing a formed honeycomb structure in the present embodiment, the passage 22 for preform material for a honeycomb structure is constituted of the cylinder 6 and the drum 7. The screen 4 is not disposed in a boundary between the cylinder 6 and the drum 7, and is disposed in the vicinity of the die 3 for forming the formed honeycomb structure in the drum 7.

As to a position where the screen 4 is disposed, the screen is disposed in the vicinity of the die 3 for forming the formed honeycomb structure so as to reduce an amount of the preform material for a honeycomb structure 5b remaining in the drum 7 as compared with the conventional manufacturing method. There is not any special restriction on the position, but the screen 4 is preferably disposed in, for example, a position where a distance from the die 3 for forming the formed honeycomb structure is twice or less an inner diameter of the passage 22 for preform material for a honeycomb structure, specifically twice or less the inner diameter of the cylinder 6.

According to such constitution, in a case where the preform material for a honeycomb structure 5b is extruded to the position of the screen 4 disposed in the passage 22 for preform material for a honeycomb structure, and thereafter the passage 22 for preform material for a honeycomb structure is charged with the new preform material for a honeycomb structure 5a, it is possible to effectively reduce the influence on the extrusion forming caused by the formation of the boundary portion 8 between the newly charged preform material for a honeycomb structure 5a and the remaining preform material for a honeycomb structure 5b.

It is to be noted that there is not any special restriction on a distance between the screen 4 and the die 3 for forming the formed honeycomb structure, but in the method for manufacturing a formed structure in the present embodiment, the distance is set to ⅔ or less of that in the conventional method, preferably ½ or less.

Moreover, in the method for manufacturing a formed structure in the present embodiment, a length of the drum 7 in an extrusion direction is reduced, so that the screen 4 can be disposed close to the die 3 for forming the formed honeycomb structure.

The influence caused by the reduction or enlargement of the passage 22 for preform material for a honeycomb structure in the drum 7 may include a fluctuation in characteristics of preform material for a honeycomb structure and a fluctuation in speed passing through the passage 22 of preform material for a honeycomb structure caused by the compression or expansion of a volume of the preform material for a honeycomb structure 5 in a section of the passage 22 for preform material for a honeycomb structure.

As described above, in a case where the length of the drum 7 in the extruding direction is shortened, the passage 22 for preform material for a honeycomb structure is not easily reduced or enlarged. Therefore, an influence on formability sometimes increases. However, the influence on the formability is carefully investigated, and it is experimentally sufficiently confirmed that there is not any substantial influence on the formability in a range of an existing extrusion forming speed, when a lower limit of the length of the drum 7 is assessed and optimized. Accordingly, the length of the drum 7 in the extrusion direction can be shortened.

In the conventional method for manufacturing a formed honeycomb structure, as shown in FIG. 8(a), usually the length of the drum 27 in the extrusion direction is twice or more the outer diameter (synonymous with the inner diameter of the cylinder 26 constituting the passage 22 for preform material for a honeycomb structure) of the preform material for a honeycomb structure 25a to be charged. For example, when the outer diameter of the preform material for a honeycomb structure 25a to be charged is about 300 mm, the length of the drum 27 is 600 mm or more, and a distance from the screen 24 to the backside of the die 23 for forming a honeycomb structure is 600 mm or more.

In the method for manufacturing a formed honeycomb structure in the present embodiment, the length of the drum 27 in the extrusion direction, which has heretofore been slightly redundant, is intensively investigated. Accordingly, for example, as shown in FIGS. 1(a) and 1(b), when the outer diameter of the preform material for a honeycomb structure 5a to be charged is about 300 mm, the length of the drum 7 is set to 400 mm or less, for example, about 400 to 300 mm. The distance from the screen 4 to the backside of the formed honeycomb structure forming die 3 for forming a honeycomb structure may also be set to about 400 to 300 mm, which is shorter than the distance in the conventional manufacturing method.

Moreover, although not shown, the screen can be similarly disposed in the vicinity of the die for forming the formed honeycomb structure even in a case where a combining type forming machine is used.

In the combining type forming machine, the preform material for a honeycomb structure is extruded not with a plunger, but by the rotation by an in-line screw, and an inner diameter of the passage for preform material for a honeycomb structure in a distant end of a screw portion corresponds to an outer diameter of the preform material for a honeycomb structure in a plunger system.

The drum is disposed between the distant end of this screw portion and the die for forming the formed honeycomb structure, and the screen is disposed between the distant end of the screw portion and the drum.

Moreover, there is not any special restriction on the operation to reduce the frictional resistances between the inner face of the passage 22 for preform material for a honeycomb structure and the preform material for a honeycomb structure 5 as long as the frictional resistance between the inner face of the passage 22 for preform material for a honeycomb structure and the preform material for a honeycomb structure 5 is effectively reduced in the method. Examples of the method may include an operation to dispose lubricating oil or a lubricating material between the inner face of the passage 22 for preform material for a honeycomb structure and the preform material for a honeycomb structure 5 and/or an operation to modify a surface property of the inner face of the passage 22 for preform material for a honeycomb structure.

There will be described hereinafter the formed honeycomb structure manufacturing method of the present embodiment in more detail.

In the method for manufacturing a formed honeycomb structure in the present embodiment, first there is prepared the preform material for a honeycomb structure 5 to be extruded to form the formed honeycomb structure 10.

A method of preparing the preform material for a honeycomb structure 5 can be performed in a similar manner to that for the conventional manufacturing method.

For example, there is a method in which a predetermined material powder and water are mixed with a mixer, the mixture is next kneaded with a kneader, and the clay is further kneaded under vacuum to prepare the material.

Moreover, a material of the material for forming a honeycomb structure 5 can be appropriately selected depending on the formed honeycomb structure 10 to be obtained.

For example, to obtain the formed honeycomb structure 10 for use in an application to purify an automobile exhaust gas, as a main material of the material for forming a honeycomb structure 5, a cordierite ceramic is preferably usable which is superior in heat resistance and low thermal expansion.

This cordierite ceramic preferably contains a main material of a composition including: 0 to 20 mass % of kaolin (Al₂O₃.2SiO₂.2H₂O) having an average particle diameter of 5 to 10 μm; 37 to 40 mass % of talc (3MgO.4SiO₂.H₂O) having an average particle diameter of 15 to 30 μm; 15 to 45 mass % of aluminum hydroxide having an average particle diameter of 1 to 10 μm: 0 to 15 mass % of aluminum oxide having an average particle diameter of 4 to 8 μm; and 10 to 20 mass % of molten silica or quartz having an average particle diameter of 3 to 100 μm.

It is to be noted that as the material for forming a honeycomb structure, in addition to the above-described cordierite ceramic, it is also preferable to use one selected from the group consisting of alumina, mullite, spinel, aluminum titanate, titania, zirconia, silicon nitride, aluminum nitride, silicon carbide, and lithium aluminum silicate (LAS) or a compound of them, or an absorptive material such as stainless steel, aluminum alloy, active carbon, silica gel, or zeolite.

Moreover, if necessary, a desired additive agent may be added to the material for forming a honeycomb structure 5 for use in the method for manufacturing a formed honeycomb structure in the present embodiment.

Examples of the additive agent include a binder, a dispersant for promoting dispersion of the main material into a medium liquid, and a pore former for forming pores.

Examples of the binder include hydroxypropyl methyl cellulose, methyl cellulose, hydroxyethyl cellulose, carboxyl methyl cellulose, polyvinyl alcohol, and polyethylene terephthalate. Examples of the dispersant include ethylene glycol, dextrin, fatty acid soap, and polyalcohol. Examples of the pore former include graphite, cokes, flour, starch, foamed resin, absorptive resin, phenol resin, polyethylene terephthalate, fly ash balloon, silica balloon, silica gel, alumina gel, organic fiber, inorganic fiber, carbon fiber, solid fiber of these materials, and hollow fiber.

These additives can be used alone or as a combination of two or more depending on a purpose for use.

As to the material for forming a honeycomb structure 5, usually, about 10 to 40 parts by mass of water is mixed with 100 parts by mass of a mixed material powder of the main material and the additive added if necessary, and they are kneaded to obtain a plastic mixture.

The raw materials may be classified or sieved to remove coarse particles before they are mixed.

Moreover, to eliminate aggregation of material particles during the mixing, a mixing method having an improved dispersion degree is preferably adopted.

It is to be noted that water may be added during the mixing of the material powders.

Next, a predetermined amount of the resultant material for forming a honeycomb structure 5 is charged into a vacuum clay kneader, deaerated, kneaded with a screw, and packed. The material for forming a honeycomb structure 5a to be charged as a cylindrical clay cluster having a predetermined length is sorted out in accordance with the inner diameter of the passage 22 for preform material for a honeycomb structure; that is, inner diameter of the cylinder 6 constituting the passage.

In the method for manufacturing a formed honeycomb structure in the present embodiment, the outer diameter of the preform material for a honeycomb structure 5a is preferably set to be slightly smaller than the inner diameter of the passage 22 for preform material for a honeycomb structure.

It is to be noted that the outer diameter of the cylindrically shaped material 5a can be varied depending on the inner diameter of a tip metal attached to the distant end of the vacuum clay kneader.

In the method for manufacturing a formed honeycomb structure in the present embodiment shown in FIGS. 1(a) and 1(b), there is obtained the preform material for a honeycomb structure 5a having a volume which is sufficient larger than that of the formed honeycomb structure 10 to be manufactured so that a plurality of formed honeycomb structures 10 can be continuously extrusion-formed using a batch of a preform material for a honeycomb structure 5a.

It is to be noted that the inner diameter of the passage 22 for preform material for a honeycomb structure of the forming machine 1 for use can be determined depending on the outer diameter of the formed honeycomb structure 10 to be manufactured.

For example, the outer diameter of the formed honeycomb structure 10 broadly ranges from about 50 to 300 mm.

In general, the formed honeycomb structure 10 having an outer diameter of about 50 to 200 mm is used as a honeycomb structure for use in purifying an exhaust gas from a car or a small truck having a small engine displacement.

When the engine displacement increases, the outer diameter as well as the length of the formed honeycomb structure 10 increases.

In general, the formed honeycomb structure 10 having an outer diameter of about 200 mm or more is used as a honeycomb structure for use in purifying an exhaust gas from a large-displacement large-sized vehicle such as a diesel truck or a bus.

Next, the cylinder 6 of the passage 22 for preform material for a honeycomb structure is charged with the resultant preform material for a honeycomb structure 5a.

The passage 22 for preform material for a honeycomb structure is constituted of the cylinder 6 and the drum 7, and the drum 7 is connected to the die 3 for forming the formed honeycomb structure.

Moreover, the screen 4 is disposed closer to the die 3 for forming the formed honeycomb structure than to the boundary between the cylinder 6 and the drum 7 in the drum 7.

A thin sheet-shaped metal mesh is usable in the screen 4, and the screen is held by a holding portion 16 which is a disc-shaped metal-made porous plate having a large number of through holes.

Moreover, in the method for manufacturing a formed honeycomb structure in the present embodiment, there are employed an operation to dispose the lubricating oil or the lubricating material between the inner face of the passage 22 for preform material for a honeycomb structure and the material for forming a honeycomb structure 5, and/or an operation to modify the surface property of the inner face of the passage 22 for preform material for a honeycomb structure. Accordingly, one may reduce a difference of an extrusion speed of the preform material for a honeycomb structure 5 between the central portion and the outer peripheral portion of the passage 22 for preform material for a honeycomb structure. Moreover, the spread of the boundary portion 8 generated at a time when the preform material for a honeycomb structure 5 is later additionally charged is reduced.

The above lubricating oil preferably contains a main component of at least one selected from the group consisting of various types of commercially available synthetic lubricating oils, hydrocarbons, petroleum-based oil, and edible oil.

It is to be noted that examples of the petroleum-based oil include kerosene and light oil. Examples of the edible oil include rapeseed oil, soybean oil, corn oil, olive oil, and sesame oil.

Moreover, the lubricating material preferably contains, as a main component, at least one selected from the group consisting of black lead, graphite, cokes, carbon fiber, and molybdenum disulfide.

The lubricating oil may be combined with the lubricating material for use.

Furthermore, such lubricating oil or lubricating material can obtain an effect of preventing the outer face of the material for forming a honeycomb structure 5 from being dried.

Any type of drying preventive, antiseptic, pH stabilizer or the like may be added.

In the operation to modify the surface property of the inner face of the passage 22 for preform material for a honeycomb structure, surface roughness (Ra, Rmax, Ry, Rz or the like) or the surface property quantified by undulation is smoothened, or surface tension is reduced, and both of wear resistance and friction property are improved.

Specifically, examples of a method of machining the inner face of the drum 7 include a method of reducing a working trace in a circumferential direction by lathing with a tuning tool. The operation can be realized by performing grinding and polishing with a grindstone as surface finishing after machining.

Moreover, the operation can be realized by a sand blasting method.

Since the drum 7 is generally made of a metal material such as an iron steel material, a stainless steel material, or a titanium material, any type of thermal treatment or surface hardening treatment is preferably perform so as to improve the wear resistance.

Moreover, there may be used a ceramic material such as alumina, zirconia, or silicon nitride, or a non-metal material such as cermet.

Furthermore, the machined surface may be subjected to any type of coating treatment such as hard chromium plating treatment.

To improve a lubricating property, composite plating is preferable in which dispersant particles of hexagonal boron nitride, molybdenum disulfide, or tungsten disulfide are uniformly dispersed in a plating matrix of nickel (Ni).

Additionally, there is preferably usable sulfuring or sulphonitriding for generating a sulfide film, ion injection treatment, CVD treatment, PVD treatment, evaporation treatment, plasma treatment, thermal spraying or the like.

Various types of surface treatments described above are preferably applied to not only the inner face of the passage 22 for preform material for a honeycomb structure but also the surface of a screw or the like, and they are also useful as a measure against corrosion such as rusting in the iron steel material.

There is not any special restriction on a shape of the formed honeycomb structure 10 obtained by the method for manufacturing a formed honeycomb structure in the present embodiment, and various shapes of formed honeycomb structures 10 can be obtained using the formed honeycomb structure forming die 3 having a desired shape.

Examples of an outer shape of the formed honeycomb structure 10 to be extruded may include: a columnar shape whose end-face shape is perfectly circular or elliptical; a square rod shape whose end-face shape is a polygonal shape such as a triangular or quadrangular shape; and a columnar or square-rod shape whose side face is curved into a V-shape. Examples of a shape of the through channels of the formed honeycomb structure 10 include: a polygonal sectional shape such as a quadrangular shape or an octagonal shape; a perfectly circular shape; an elliptical shape; and a combination of these shapes, as mentioned previously.

Next, the material for forming a honeycomb structure 5 charged in the passage 22 for preform material for a honeycomb structure is extruded to form the structure.

There is not any special restriction on a method of extruding the material for forming a honeycomb structure 5 to form the structure, but there is preferably usable the plunger-type extrusion forming to press the material for forming a honeycomb structure 5 by use of the plunger 11 for pressing the material for forming a honeycomb structure as shown in FIGS. 1(a) and 1(b).

After extrusion-forming the formed structure having a predetermined length from the die 3 for forming the formed honeycomb structure in this manner, the extruded formed structure is cut to obtain the cylindrical formed honeycomb structure 10 in which a plurality of through holes are defined by the partition walls.

Moreover, in the method for manufacturing a formed honeycomb structure in the present embodiment, for example, two drums 7 may be used. For example, a first drum (reduction or enlargement drum) is disposed between the cylinder 6 and the drum 7, and further a second drum (reduction or enlargement drum) is disposed between the screen 4 and the die 3 for forming the formed honeycomb structure. Accordingly, the screen 4 can be disposed in the vicinity of the die 3 for forming the formed honeycomb structure.

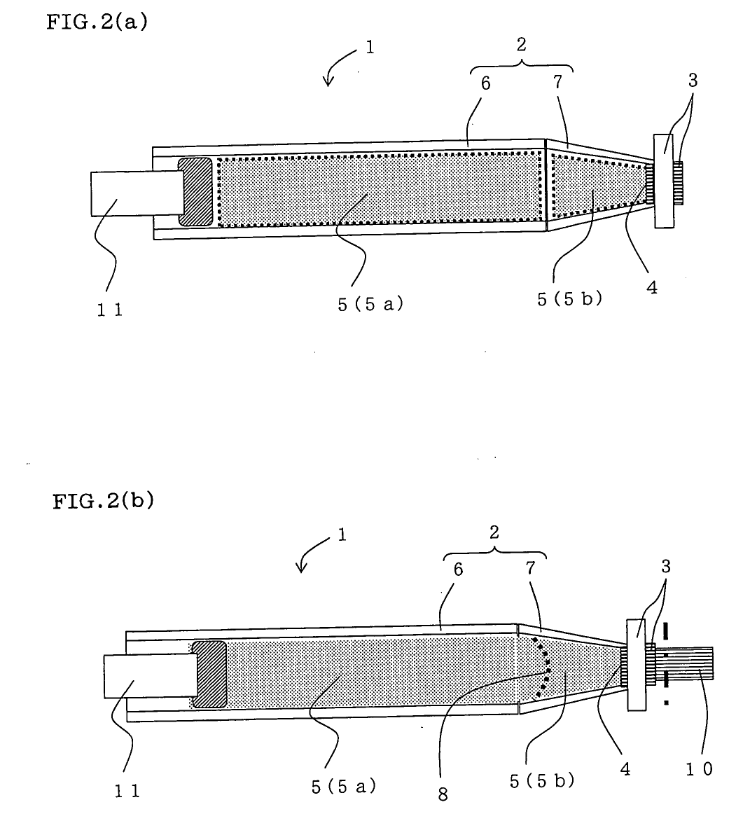

Furthermore, as shown in FIGS. 2(a) and 2(b), the die 3 for forming the formed honeycomb structure may also have a function of the holding portion 16 (see FIG. 1(a)) of the screen 4. The screen 4 may be attached to the backside of the die 3 for forming a formed honeycomb structure, or assembled into the die 3 to perform the extrusion forming.

FIGS. 2(a) and 2(b) are explanatory views schematically showing another example of the step of extruding the material for forming a honeycomb structure to form the honeycomb structure in the embodiment of the method for manufacturing a formed honeycomb structure according to the present invention.

In FIGS. 2(a) and 2(b), the same elements as those of the forming machine shown in FIG. 1(a) are denoted with the same reference numerals, and description thereof is omitted.

In such method, as raw materials, for example, water and a binder are blended with a cordierite forming material containing main materials of talc, kaolin and alumina. After dispersing and mixing the raw materials, the resultant material for forming a honeycomb structure is kneaded, and extruded into a columnar shape with a clay kneading machine. The resultant material for forming a honeycomb structure having an outer diameter of about 300 mm is extrusion-formed with the forming machine 1, and there can be obtained a formed honeycomb structure which does not include any boundary portion between the material for forming a honeycomb structures and which has an outer diameter of about 210 mm.

It is to be noted that in a case where the honeycomb structure is manufactured using the formed structure obtained in this manner, the resultant formed structure is dried, and cut into a predetermined length to obtain a dried structure, and a group of cells are alternately closed in opposite end faces of the dried structure. Thereafter, the structure is fired to obtain a fired structure.

Next, after grinding and removing the partition walls for about three cells from an outer peripheral wall and an outermost periphery of the resultant fired structure, the outer periphery is coated with a ceramic coating material to form the outer peripheral wall. Accordingly, a cordierite honeycomb structure can be obtained.

According to such method, it is possible to manufacture a honeycomb structure in which, for example, a cell sectional shape is a quadrangular shape, a partition wall thickness is 0.3 mm, a reference cell density is 200 cpsi (31 cells/cm²), and an outer shape of the honeycomb structure having the coated outer periphery is columnar (outer diameter: 191 mm, length: 203 mm).

This honeycomb structure has a porosity of 65%, an average pore diameter of 12 μm, and an average thermal expansion coefficient of about 0.4×10⁻⁶/° C. in an axial direction at 40 to 800° C.

Moreover, although not shown, in the method for manufacturing a formed honeycomb structure in the present embodiment, a color powder may be applied to an end face of the later charged material for forming a honeycomb structure on the side of the die so that a position of a boundary portion of the later charged material for forming a honeycomb structure can be easily distinguished later.

Accordingly, it is possible to visually easily distinguish the position of the boundary portion of the later charged material for forming a honeycomb structure.

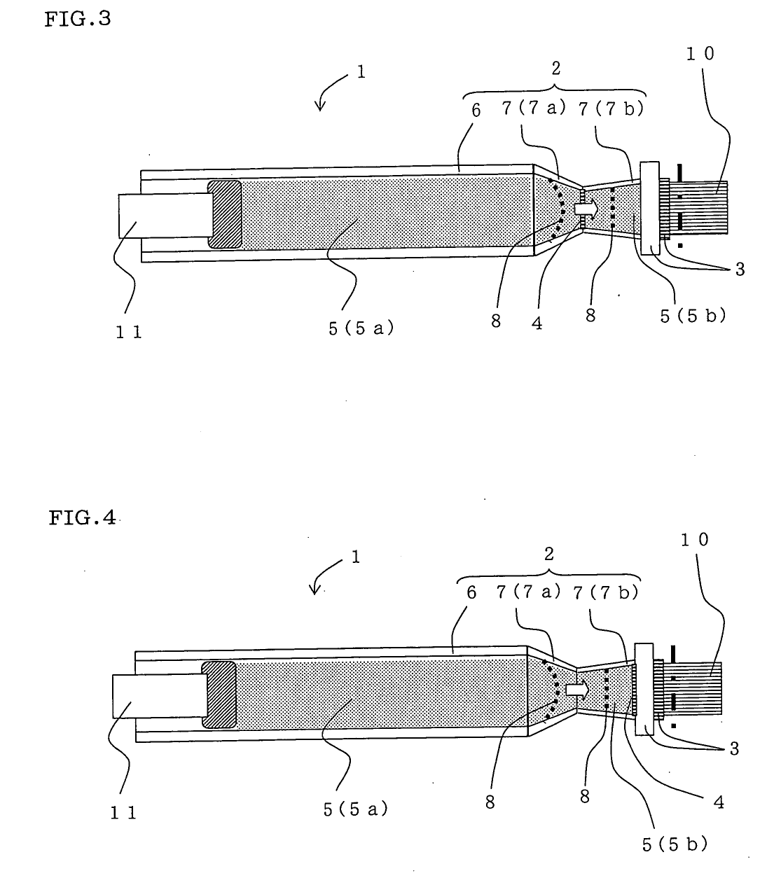

Furthermore, in the method for manufacturing a formed honeycomb structure in the present embodiment, as shown in FIG. 3, extrusion forming may be performed using a passage 22 for preform material for a honeycomb structure whose inner diameter is enlarged from a position provided with a screen 4 toward one end portion provided with formed honeycomb structure forming dies 3. Alternatively, the extrusion forming may be performed using the passage 22 for preform material for a honeycomb structure whose inner diameter is reduced toward one end portion and thereafter enlarged.

The drum 7 shown in FIG. 3 is constituted of: a reduction drum 7a constituted by reducing the inner diameter of the passage 22 for preform material for a honeycomb structure; and an enlargement drum 7b obtained by enlarging the inner diameter of the passage 22 for preform material for a honeycomb structure.

Here, FIG. 3 is an explanatory view schematically showing another example of the step of extruding the material for forming a honeycomb structure to form the formed honeycomb structure in the method for manufacturing a formed honeycomb structure in the present embodiment.

A ratio (reduction ratio) between the inner diameter of the cylinder 6 (or the outer diameter of the material for forming a honeycomb structure 5) and a reduced portion inner diameter is in a range of 5 to 95%, and a ratio (enlargement ratio) between the inner diameter of the reduced portion and the outer diameter of the formed structure is preferably in a range of 105 to 200%.

A length of the reduction drum 7a is preferably set in such manner that the reduction angle formed between the two plates defining the drum with facing each other becomes 10 to 90 degrees, a length of the enlargement drum 7b is set preferably in such manner that the enlargement angle formed between the two plates defining the drum with facing each other becomes 5 to 45 degrees, and the enlargement angle is preferably set to be smaller than the reduction angle.

An optimum combination of the reduction ratio, the enlargement ratio, the reduction angle, the enlargement angle, the cylinder inner diameter, the reduced portion inner diameter, the drum lengths of the reduced and enlarged portions, and the formed structure outer diameter is also influenced by a material for forming a honeycomb structure property for actual use in a production site. Therefore, design specifications of the optimum combination are experimentally set prior to the production.

It is to be noted that FIG. 3 shows a step of pressing the material for forming a honeycomb structure 5 by use of the plunger 11 for pressing the material for forming a honeycomb structure 5 in the plunger type extrusion forming. However, in another method, for example, connecting type forming, the extrusion forming may be performed using the passage 22 for preform material for a honeycomb structure whose inner diameter is enlarged from the position provided with the screen toward one end portion provided with the die for forming a honeycomb structure.

In the method for manufacturing a formed honeycomb structure shown in FIG. 3, the inner diameter of the passage 22 for preform material for a honeycomb structure is not reduced after the screen 4. Therefore, the distribution in speed for passing the passage of the material for forming a honeycomb structure 5 is improved, and the boundary portion 8 between the previously charged material for forming a honeycomb structure and the later charged material for forming a honeycomb structure 5a can be effectively prevented from being formed into a long parabolic shape.

The formed honeycomb structure 10 including the boundary portion 8 cannot be used as a product, and has to be disposed of after formed. Therefore, according to the method for manufacturing a formed honeycomb structure in the present embodiment, the formed honeycomb structure 10 including such boundary portion 8 can be reduced, and the material for forming a honeycomb structure 5 can be effectively used.

Moreover, since the material for forming a honeycomb structure 5 is smoothly supplied to the outer peripheral portion of the formed honeycomb structure 10, a pressure-attached property of the partition wall in the outer peripheral portion of the formed honeycomb structure 10 is improved. An outer wall constituting the formed honeycomb structure 10 has fewer defects, and it is possible to obtain the formed honeycomb structure 10 having an excellent appearance.

According to such method, as raw materials, for example, water and a binder are blended with a cordierite forming material containing main materials of talc, kaolin, and alumina described above. After dispersing and mixing the materials, the resultant material for forming a honeycomb structure is kneaded, and extruded into a columnar shape with a clay kneading machine. The resultant material for forming a honeycomb structure having an outer diameter of about 300 mm is extrusion-formed with the forming machine 1 including the reduction or enlargement drum 7, and a formed honeycomb structure having an outer diameter of about 250 mm can be obtained.

It is to be noted that there is not any special restriction on an inner diameter of a reduced portion, but in the present embodiment, the inner diameter is set to 210 mm so as to obtain a reduction ratio of 65% and an enlargement ratio of 120%.

Moreover, a length of a reduction drum 7a is set so that reduction angles are both 30 degrees, and a length of an enlargement drum 7b is set so that enlargement angles are both 15 degrees.

An extrusion-formed pattern is substantially flat and satisfactory, and it is possible to obtain a satisfactory honeycomb structure which does not involve any conspicuous cell deformation.

It is to be noted that to manufacture the honeycomb structure by use of the formed structure obtained in this manner, the resultant formed structure is dried, and cut into a predetermined length to obtain a dried structure, and a group of cells are alternately closed in opposite end faces of the dried structure. Thereafter, the structure is fired to obtain a fired structure.

Next, after grinding and removing partition walls for about three cells from an outer peripheral wall and an outermost periphery of the resultant fired structure, the outer periphery is coated with a ceramic coating material to form the outer peripheral wall. Accordingly, a cordierite honeycomb structure can be obtained.

According to such method, it is possible to manufacture a honeycomb structure in which a cell sectional shape is a quadrangular shape, a partition wall thickness is 0.3 mm, a reference cell density is 200 cpsi (31 cells/cm²), and an outer shape of the honeycomb structure having the coated outer periphery is columnar (outer diameter: 229 mm, length: 305 mm).

It is to be noted that this honeycomb structure has a porosity of 60%, an average pore diameter of 12 μm, and an average thermal expansion coefficient of about 0.4×10⁻⁶/° C. in an axial direction at 40 to 800° C.

Moreover, in a case where the material for forming a honeycomb structure 5 is extruded from the cylinder 6 in a plunger type or a screw portion (cylinder) in a combining type, the material is once reduced, and the material is next enlarged toward the die 3 for forming a formed honeycomb structure, as shown in FIG. 3, the screen 4 may be disposed between the reduction drum 7a and the enlargement drum 7b to perform the extrusion forming. However, although not shown, the screen may be disposed between, for example, the cylinder and the reduction drum to perform the extrusion forming. As shown in FIG. 4, a screen 4 is not disposed between a reduction drum 7a and an enlargement drum 7b, and the screen 4 may be disposed on the backside of or in die 3 for forming a formed honeycomb structure.

It is to be noted that in FIGS. 3 and 4, elements similar to those of the forming machine shown in FIG. 1(a) are denoted with the same reference numerals, and description thereof is omitted.

Moreover, although not shown, in a case where a material for forming a honeycomb structure is enlarged from a cylinder toward the die for forming a formed honeycomb structure, the screen may be disposed between the cylinder and the enlargement drum to perform the extrusion forming.

Furthermore, the screen may be disposed in the enlargement drum to perform the extrusion forming, or the screen may be disposed on the backside of or in the die for forming a formed honeycomb structure to perform the extrusion forming.

In a case where the screen 4 is directly disposed on the backside of the die 3 for forming a formed honeycomb structure as shown in FIG. 4, when the forming is restarted after having been retarded, a material for forming a honeycomb structure 5 of a portion (reduced flow portion) where the forming is stopped and the flow is reduced is immediately extruded together with the material for forming a honeycomb structure 5 retained in the die 3 for forming a formed honeycomb structure. Formability is little influenced, and it is easy to handle a formed honeycomb structure 10 including the boundary portions 8.

It is to be noted that the embodiments shown in FIGS. 3 and 4 may be applied to the ram (plunger) or combining type extrusion forming.

Next, there will be described another embodiment of the formed honeycomb structure manufacturing method of the present invention.

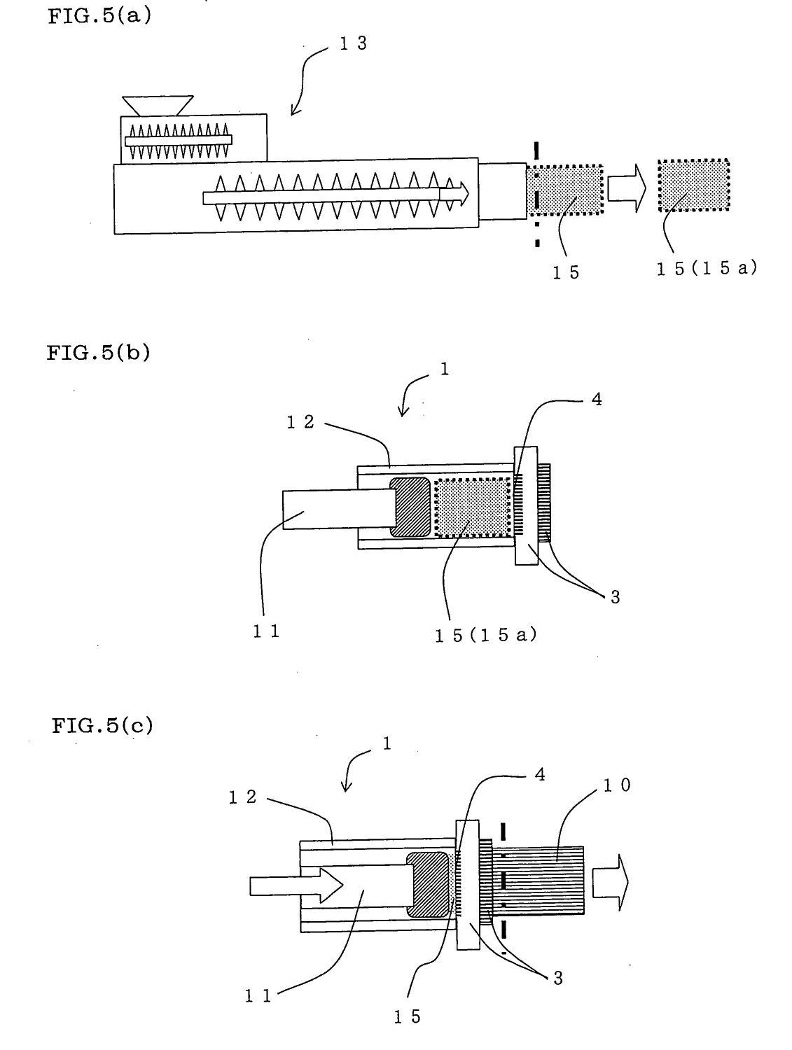

FIGS. 5(a) to 5(c) are explanatory views schematically showing an example of a step of extruding a material for forming a honeycomb structure to form a formed honeycomb structure in the other embodiment of the method for manufacturing a formed honeycomb structure according to the present invention.

As shown in FIGS. 5(a) to 5(c), the method for manufacturing a formed honeycomb structure in the present embodiment is a method of: charging, with a material for forming a honeycomb structure 15, a passage 12 for preform material for a honeycomb structure whose one end portion is provided with die 3 for forming a formed honeycomb structure; and extruding the charged material for forming a honeycomb structure 15 from the die 3 for forming a formed honeycomb structure to obtain a formed honeycomb structure 10. An inner diameter of the passage 12 for preform material for a honeycomb structure 12 is set to be substantially equal to an outer diameter of the formed honeycomb structure 10 to be extrusion-formed. A screen 4 for filtering foreign matters included in the material for forming a honeycomb structure 15 is disposed in the vicinity of the die 3 for forming a formed honeycomb structure in the passage 12 for preform material for a honeycomb structure. Moreover, an operation is performed to reduce frictional resistances between an inner face of the passage 12 for preform material for a honeycomb structure and the material for forming a honeycomb structure 15.

It is to be noted that FIGS. 5(b) and 5(c) show a step of extrusion-forming the formed honeycomb structure with the screen 4 disposed on the backside of or in the die 3 for forming a formed honeycomb structure.

In the method for manufacturing a formed honeycomb structure in the present embodiment, the inner diameter of the passage 12 for preform material for a honeycomb structure is set to be substantially equal to the outer diameter of the formed honeycomb structure 10 to be extrusion-formed, and a cylinder and a drum constituting a conventional passage for preform material for a honeycomb structure are integrated. According to such structure, a plunger 11 can press the material until the position just before the die 3 for forming a formed honeycomb structure. It is possible to reduce boundary portions generated in a case where the material for forming a honeycomb structure 15 is later additionally charged.

The above-described boundary portions of the material for forming a honeycomb structure have discontinuity. The boundary portions remaining in a product are unfavorable.

It is to be noted that in the method for manufacturing a formed honeycomb structure in the present embodiment, as shown in FIG. 5(a), the material for forming a honeycomb structure 15 having an amount corresponding to that of one formed honeycomb structure 10 is continuously prepared with a clay kneader 13 to obtain a preform material for a honeycomb structure 15a which is a cylindrical clay-like cluster having a size corresponding to the inner diameter of the passage 12 for preform material for a honeycomb structure (i.e., a size corresponding to the outer diameter of the formed honeycomb structure 10 to be extrusion-formed. As shown in FIGS. 5(b) and 5(c), the passage 12 for preform material for a honeycomb structure is preferably charged with this cylindrically shaped material 15a to perform the extrusion forming.

It is to be noted that to obtain the cylindrically shaped material 15a having an amount corresponding to that of one formed honeycomb structure 10, in actual, the cylindrically shaped material 15a is preferably obtained using the material for forming a honeycomb structure 15 having an amount including: an amount of one formed honeycomb structure 10; and amounts of portions corresponding to finishing allowances of opposite end faces of the formed honeycomb structure.

Since the material for forming a honeycomb structure 15a charged in the passage 12 for preform material for a honeycomb structure is used up every forming, the material for forming a honeycomb structure 15 hardly remains in the passage 12 for preform material for a honeycomb structure, and this eliminates generation of boundary portions in the material for forming a honeycomb structure 15 itself.

It is to be noted that in a case where the forming is actually performed, a slight amount of the material for forming a honeycomb structure 15 sometimes remains in the die 3 for forming a formed honeycomb structure. However, in the formed honeycomb structure 10 obtained in the next extrusion forming, a portion constituted of the remained material for forming a honeycomb structure 15 is used as the finishing allowances of the end faces of the formed honeycomb structure 10, and does not remain in the product.

In a case where the forming is performed using the material for forming a honeycomb structure 15 having the amount corresponding to that of one formed honeycomb structure 10 in this manner, as shown in FIGS. 5(a) to 5(c), the preform material for a honeycomb structure 15a having the amount corresponding to that of one formed honeycomb structure 10 is continuously obtained with the clay kneader 13. The resultant preform material for a honeycomb structure 15a is successively transferred to the passage 12 for preform material for a honeycomb structure of a forming machine 1, and the passage 12 for preform material for a honeycomb structure is charged with the transferred material for forming a honeycomb structure 15a to perform intermittent forming.

In the method for manufacturing a formed honeycomb structure in the present embodiment, the formed honeycomb structure cannot be continuously formed unlike the conventional manufacturing method, but a structure of the passage 12 for preform material for a honeycomb structure is miniaturized. Since this facilitates a charging operation with the material for forming a honeycomb structure 15, time required for charging the material for forming a honeycomb structure 15 can be largely reduced.

The passage 12 for preform material for a honeycomb structure is not constituted of a cylinder and a drum unlike the conventional manufacturing method, and the channel is simply constituted of the cylindrical passage 12 for preform material for a honeycomb structure only.

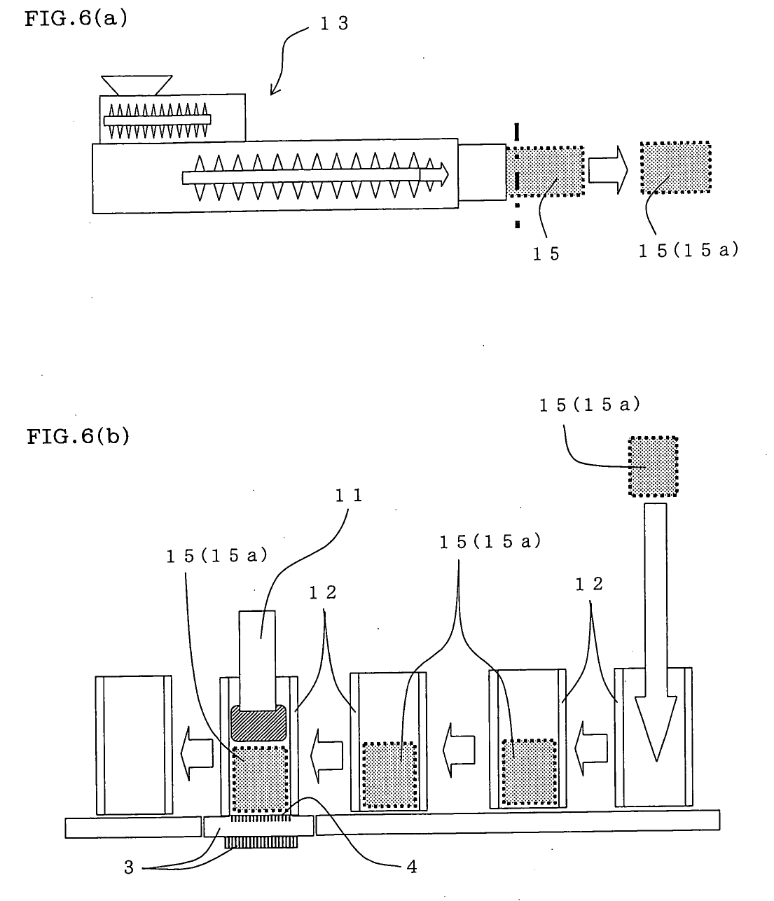

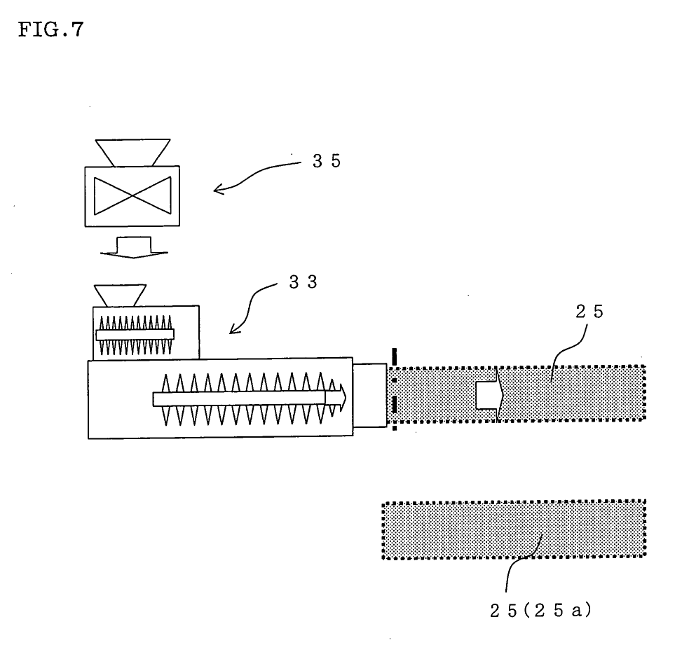

Moreover, in the method for manufacturing a formed honeycomb structure in the present embodiment, as shown in FIGS. 6(a) and 6(b), there are prepared a plurality of cartridge type passages 12 for preform material for a honeycomb structure for exclusive use in accordance with an outer diameter of a formed honeycomb structure 10. The passages for preform material for a honeycomb structure are disposed along a circumference or in series on a rotary table. During extrusion forming in one passage 12a for preform material for a honeycomb structure charged with a material for forming a honeycomb structure 15 by use of a plunger 11, another passage 12b for preform material for a honeycomb structure where the forming has been completed is charged with the material for forming a honeycomb structure 15.

In this case, the passage 12b for preform material for a honeycomb structure charged with the material for forming a honeycomb structure 15 is moved to a position provided with the plunger 11 to perform the forming. In consequence, the extrusion forming can be realized more quickly.

Especially in recent years, a computer control technology and a robotization technology have been developed. Therefore, substantially continuous extrusion forming can be realized substantially without deteriorating forming operation efficiency.

Here, FIGS. 6(a) and 6(b) are explanatory views schematically showing another example of a step of extruding a material for forming a honeycomb structure to form a formed honeycomb structure in another embodiment of the method for manufacturing a formed honeycomb structure according to the present invention.

Moreover, in FIGS. 6(a) and 6(b), elements similar to those of the forming machine shown in FIG. 1(a) are denoted with the same reference numerals, and description thereof is omitted.

In the method for manufacturing a formed honeycomb structure in the present embodiment, a length of the passage 12 for preform material for a honeycomb structure of the forming machine 1 in an extruding direction can be shortened as compared with the heretofore used passage for preform material for a honeycomb structure. In consequence, it is possible to simplify a hydraulic mechanism of the plunger 11 and miniaturize the forming machine 1.

With the miniaturization of the forming machine 1, the passage 12 for preform material for a honeycomb structure can be easily changed in accordance with the outer diameter of the formed honeycomb structure 10.

Specifically, the passage 12 for preform material for a honeycomb structure has a structure in which the conventional cylinder and drum are integrated, but may be changed to a cartridge type structure in accordance with an outer shape of the formed honeycomb structure 10.

There can be easily obtained the preform material for a honeycomb structure 15a having a size corresponding to an inner diameter of the passage 12 for preform material for a honeycomb structure (i.e., a size corresponding to an outer diameter of the formed honeycomb structure 10 to be extrusion-formed), when a throttle or enlargement drum is added to a distant end of the clay kneader 13.

It is to be noted that in FIGS. 5(a) to 5(c), there is obtained the preform material for a honeycomb structure 15a having the amount corresponding to that of one formed honeycomb structure 10 (in actual, the amount includes the amount of one formed honeycomb structure, and the amount of the portion corresponding to the end-face finishing allowance) to form the formed honeycomb structure 10. However, although not shown, for example, there may be obtained: a preform material for a honeycomb structure having an amount corresponding to that of two formed honeycomb structures (in actual, the amount includes an amount for two formed honeycomb structures, and an amount for portions corresponding to end-face finishing allowances); or a preform material for a honeycomb structure having an amount corresponding to that of three or more formed honeycomb structures (in actual, the amount includes an amount for the plurality of formed honeycomb structures, and an amount for portions corresponding to end-face finishing allowances). However, as the number of formable structures increases, the length of the preform material for a honeycomb structure increases. Therefore, there is preferably obtained a preform material for a honeycomb structure capable of forming about one to three formed honeycomb structures.

Especially, in the present embodiment, the method for manufacturing a formed honeycomb structure is highly effective in a case where the formed honeycomb structure has a comparatively large size.

In general, the preform material for a honeycomb structure has a long columnar shape having an outer diameter of about 300 mm and a length of about 1200 mm. For example, when an outer diameter of the formed honeycomb structure to be formed is about 280 mm, and a length thereof is about 350 mm, in the conventional manufacturing method, a large amount of material for forming a honeycomb structure remains in the screen and the drum, and the number of the formed honeycomb structures obtained from one batch of preform material for a honeycomb structure decreases.

Therefore, in the conventional manufacturing method, a change interval of the material for forming a honeycomb structure becomes very short, a ratio of a material for forming a honeycomb structure change time occupied in a total manufacturing time rapidly increases, and the forming operation efficiency is lowered.

Especially, in a heavy duty diesel truck, there is sometimes a demand for a honeycomb structure filter having a size exceeding an outer diameter of 300 mm. In such case, the forming operation efficiency is further lowered.

To form a large formed honeycomb structure, it is considered that a size of the preform material for a honeycomb structure be increased, but the forming machine itself needs to be enlarged, and it is difficult to actually realize the large formed honeycomb structure.

As in the method for manufacturing a formed honeycomb structure in the present embodiment, the inner diameter of the passage 12 for preform material for a honeycomb structure is set to be substantially equal to the outer diameter of the formed honeycomb structure 10 to be extrusion-formed, and the preform material for a honeycomb structure 15a having an amount corresponding to, for example, the amount for one formed honeycomb structure 10 is obtained to form the formed honeycomb structure 10. In consequence, the forming operation efficiency can be improved (see FIGS. 5(a) and 5(b)).

As raw materials, water and a binder are blended with a cordierite forming material containing main materials of talc, kaolin, and alumina described above. After dispersing and mixing the raw materials, the resultant material for forming a honeycomb structure is kneaded, and extruded into a columnar shape with a clay kneading machine so that the size of the material is substantially equal to the outer diameter of the formed honeycomb structure. The material for forming a honeycomb structure having an outer diameter of about 430 mm is obtained.

The resultant columnar material for forming a honeycomb structure is cut so as to obtain an amount of the material including: an amount of a material for one formed honeycomb structure; an amount of a material slightly remaining in the passage for preform material for a honeycomb structure of the forming machine; and an amount of a material remaining in the die for forming a formed honeycomb structure. The material for forming a honeycomb structure for charging the forming machine is obtained.

In the forming machine for use in the present embodiment, a screen for filtering foreign matters included in the material for forming a honeycomb structure is disposed directly on the backside of the die for forming a formed honeycomb structure.

Moreover, in the present embodiment, lubricating oil is disposed between the inner face of the passage for preform material for a honeycomb structure and the material for forming a honeycomb structure, and an operation is performed to reduce frictional resistances between the inner face of the passage for preform material for a honeycomb structure and the material for forming a honeycomb structure.

Furthermore, the inner diameter of the passage for preform material for a honeycomb structure of the forming machine is set to be slightly larger than the outer shape of a honeycomb structure to be formed, so that the forming machine can be easily charged with the above-described preform material for a honeycomb structure.

The passage for preform material for a honeycomb structure of the forming machine is charged with the resultant material for forming a honeycomb structure, and the material is extruded through the die for forming a formed honeycomb structure with the plunger to form the formed honeycomb structure.

In the present embodiment, the material for forming a honeycomb structure charged in the forming machine can be effectively used, and the forming can be satisfactorily performed.

Moreover, in the present embodiment, the formed structure obtained in this manner is dried, and cut into a predetermined length to obtain a dried structure. A group of cells are alternately closed in opposite end faces of the resultant dried structure, and thereafter fired to obtain a fired structure.

It is to be noted that two or three cells in outer peripheral portions of the opposite end faces of the dried structure are not closed.

Moreover, after grinding and removing the partition walls for about five cells from an outer peripheral wall and an outermost periphery of the resultant fired structure, the outer periphery is coated with a ceramic coating material to form the outer peripheral wall. Accordingly, a cordierite honeycomb structure can be obtained so that any boundary portion of the material for forming a honeycomb structure does not remain in a product.

In the resultant honeycomb structure, a cell sectional shape is a quadrangular shape, a partition wall thickness is 0.3 mm, a reference cell density is 200 cpsi (31 cells/cm²), and an outer shape of the honeycomb structure having the coated outer periphery is columnar (outer diameter: 410 mm, length: 450 mm).

Moreover, this honeycomb structure has a porosity of 50%, an average pore diameter of 12 μm, and an average thermal expansion coefficient of about 0.4×10⁻⁶/° C. in an axial direction at 40 to 800° C.

In the method for manufacturing a formed honeycomb structure according to the present invention, one may reduce an influence caused by the formation of the boundary portion between a previously charged material for forming a honeycomb structure and a subsequently charged material for forming a honeycomb structure in a case where the forming is performed by later adding the material for forming a honeycomb structure at a time when the material for forming a honeycomb structure charged in a forming machine decreases, so that the material for forming a honeycomb structure charged in the forming machine is effectively usable.

When the resultant formed honeycomb structure is fired, there is obtained a honeycomb structure preferably for use as, for example, a filter for collecting dust or treating water, or a catalyst carrier for purifying an exhaust gas.

What is claimed is:

1. A method for manufacturing a formed honeycomb structure, comprising the steps of:
charging a preform material for a honeycomb structure into a passage for preform material for a honeycomb structure whose one end portion is provided with a die for forming the formed honeycomb structure; and
extruding a charged preform material for a honeycomb structure from the die to form the formed honeycomb structure,
wherein a screen for filtering foreign matters included in the preform material for a honeycomb structure is disposed in the vicinity of the die for forming the formed honeycomb structure in the passage for preform material for a honeycomb structure, and
wherein an operation for reduction of the frictional resistances between an inner face of the passage for preform material for a honeycomb structure and the preform material for a honeycomb structure is employed.

2. The method for manufacturing the formed honeycomb structure according to claim 1, wherein the screen is disposed in a position where a distance from the die for forming the formed honeycomb structure is twice or less an inner diameter of the passage for preform material for a honeycomb structure.

3. The method for manufacturing the formed honeycomb structure according to claim 1, wherein the operation for reduction of the frictional resistances between the inner face of the passage for preform material for a honeycomb structure and the preform material for a honeycomb structure is to dispose a lubricating oil or a lubricating material between the inner face of the passage for preform material for a honeycomb structure and the preform material for a honeycomb structure and/or an operation to modify a surface property of the inner face of the passage for preform material for a honeycomb structure.

4. The method for manufacturing the formed honeycomb structure according to claim 1, wherein the extrusion of the preform material for a honeycomb structure to form the formed honeycomb structure is carried out by use of a passage for preform material for a honeycomb structure whose inner diameter is enlarged from the position provided with the screen toward the one end portion provided with the die for forming the formed honeycomb structure.

5. The method for manufacturing the formed honeycomb structure according to claim 1, wherein the extrusion of the preform material for a honeycomb structure to form the formed honeycomb structure is carried out by use of a passage for preform material for a honeycomb structure whose inner diameter is reduced toward the one end portion and thereafter enlarged.

6. The method for manufacturing the formed honeycomb structure according to claim 1, wherein the extrusion of the preform material for a honeycomb structure to form the formed honeycomb structure is carried out by use of a passage for preform material for a honeycomb structure whose inner diameter is set to be substantially equal to an outer diameter of the formed honeycomb structure to be formed, with employment of a plunger type extrusion forming wherein the preform material for a honeycomb structure is pressed by use of a plunger for pressing the preform material for a honeycomb structure.

7. The method for manufacturing the formed honeycomb structure according to claim 1, further comprising the step of:
charging a preform material for a honeycomb structure of an amount corresponding to that of one formed honeycomb structure into the passage for preform material for a honeycomb structure to extrude the charged preform material for a honeycomb structure and form the formed honeycomb structure.
